(19) United States
(12) Patent Application Publication
(10) Pub. No.: US 2016/0328108 A1
(43) Pub. Date: Nov. 10, 2016

(54) Systems And Methods for Displaying Information

(71) Applicant: Chian Chiu Li, Fremont, CA (US)

(72) Inventor: Chian Chiu Li, Fremont, CA (US)

(21) Appl. No.: 14/708,281

(22) Filed: May 10, 2015

(51) Int. Cl. G06F 3/0485

(52) U.S. Cl. CPC G06F 3/0485

(57) ABSTRACT

Systems and methods for presenting contents using auto scroll. Contents are arranged to scroll on display automatically in multiple cycles. In an aspect, the scroll rate is adjustable by user. In another aspect, an alert sign is created before scrolling happens. In other aspects, scroll process is influenced by user gesture, voice, and eye movement.

### CROSS REFERENCE TO RELATED APPLICATION

This application claims the benefit under 35 U.S.C. Sec. 119 of provisional patent application Ser. No. 61/991,485, filed May 10, 2014.

### FEDERALLY SPONSORED RESEARCH

Not applicable

### SEQUENCE LISTING OR PROGRAM

Not applicable

### BACKGROUND

1. Field of Invention

This invention relates to displaying information, more particularly to displaying information with auto scroll.

2. Description of Prior Art

One difference between watching news on television and news on the Internet using personal computers, smartphones, or other devices is of user involvement. When watching television, a user follows what is shown on the screen passively. However, when surfing on the Internet, a user may search and then choose what to be presented. For users having a target subject or some sort of curiosity, searching and finding info of interest is exciting and satisfying. But for users with a laid-back attitude, passively watching programs provided by others may be enjoyable as well. Sometimes, a user may be in front of a display or hold a smart phone, but doesn't want to spend time doing a search or finding anything. The user may just want to watch or browse whatever contents which are displayed in a no-hurry and easy-going way. At present, after a user logs on a website, the user has to select a specific link or webpage among many choices. When viewing a webpage, a user may have to move the page up several times before turning to the next one. Therefore when viewing contents on computers, smartphones, or other gadgets, a user may have to be alert, active, make moves constantly, and respond to changing configurations properly, which may pose as a hassle for a number of people.

Accordingly, there exist a need to make viewing contents easy and convenient for users, and a need to display contents in a user-friendly, less demanding, and more automatic manner.

### Objects and Advantages

Accordingly, several main objects and advantages of the present invention are:
a). to provide an improved method and system for displaying information;
b). to provide such a method and system which scroll contents shown on display automatically;
c). to provide such a method and system which allow user to adjust the scroll rate;
d) to provide such a method and system which generate alert sign or signals before scrolling happens;
e). to provide such a method and system which restart scrolling automatically after a scroll cycle is done;
f). to provide such a method and system which use user's gesture, voice, or eye movement to control scroll process;
g). to provide such a method and system which provide switchable scrolling directions; and
h). to provide such a method and system which update presentation contents constantly.

Further objects and advantages will become apparent from a consideration of the drawings and ensuing description.

### SUMMARY

In accordance with the present invention, methods and systems are proposed to arrange easy and laid-back viewing experience for users. Specifically, methods and systems are proposed which display contents using auto-scroll method. Presentation contents may be divided into portions and portions scroll on display consecutively and automatically. A scroll cycle, which covers contents to be presented, may be arranged to restart by itself after one cycle is over. A user may adjust scroll rate and use swipe, finger or hand gesture, voice, or eye-tracking to control scroll process. Before scrolling happens, an alert sign or signals may show up as a reminder of upcoming content change.

### DRAWING FIGURES

FIG. 1 is an exemplary block diagram describing one embodiment in accordance with the present invention.

FIGS. 2 and 3 are exemplary flow diagrams showing respective scrolling embodiments in accordance with the present invention.

FIGS. 4, 5 and 6 display exemplary diagrams showing respective scrolling embodiments in accordance with the present invention.

FIG. 7 is an exemplary flow diagram showing a scrolling embodiment in accordance with the present invention.

FIGS. 8-A, 8-B, and 9 depict exemplary diagrams showing several embodiments in accordance with the present invention.

FIGS. 10, 11, and 12 are exemplary flow diagrams showing several embodiments in accordance with the present invention.

### REFERENCE NUMERALS IN DRAWINGS

| | | | |
|---|---|---|---|
| 10 | Sensor | 12 | Database |
| 14 | Communication Network | 16 | Processor |
| 18 | Processing Module | 20 | Sensor |
| 22 | Computer Readable Medium | 30 | Smartphone |
| 24 | Sensor | 36 | Close Button |
| 32 | Sign | 40 | “Yes” Button |
| 38 | Finger | 44 | Sensor |
| 42 | “No” Button | 48 | Contents |
| 46 | “Pause” Button | 82 | Service Facility |
| 80 | Client System | | |

100, 102, 104, 106, 108, 110, 112, 114, 116, 118, 120, 122, 124,
126, 128, 130, 132, 134, 136, 138, 140, 142, 144, 146, 148, 150,
152, 154, 156, 158, 160, 162, 166, 168, 170, 172, 174, 176, 178,
180, 182, 184, 186, 188, and 190 are exemplary steps.

### DETAILED DESCRIPTION

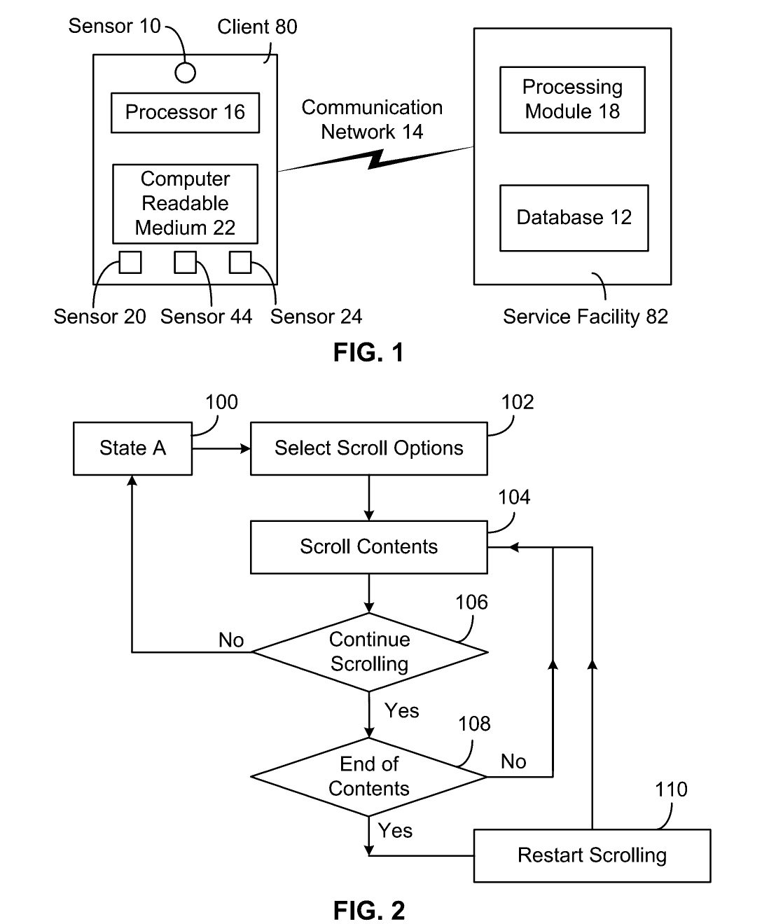

FIG. 1 is an exemplary block diagram of one embodiment according to the present invention. A client system 80 and service facility 82 are connected via a communication network 14. Client 80 may represent an electronic device, including but not limited to a desktop computer, a handheld computer, a tablet computer, a wireless gadget (such as mobile phone, smart phone, smart watch, media player, personal digital assistant (PDA), and the like), digital television (DTV), internet protocol television (IPTV), play station, smart display, etc. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run programs or sets of executable instructions stored in medium 22 for performing various functions and tasks, e.g., displaying various contents, playing games, playing music or video, surfing on the Internet, presenting advertisements, sending and receiving emails, short messages, files, and data, executing other applications, etc. Client 80 may also include input, output, and communication components, which may be individual modules or integrated with processor 16. Usually, client 80 may have a display (not shown in FIG. 1 for brevity reasons) with a graphical user interface (GUI). A display may have liquid crystal display (LCD) screen, organic light emitting diode (OLED) screen (including active matrix OLED (AMOLED) screen), or LED screen. A screen surface may be made sensitive to touches, i.e., sensitive to haptic and/or tactile contact with a user, especially in the case of smart phone, tablet computer, smart watch, and other wearable devices. A touch screen may be used as a convenient tool for user to enter input and interact with a system. Client 80 may also have a voice recognition component to receive verbal command or audio input from a user.

Service facility 82 may include a processing module 18 and database 12. Module 18 may contain one or more servers and storage devices to receive, send, store and process related data or information.

The word “server” means a system or systems which may have similar functions and capacities as one or more servers. Main components of server may include one or more processors, which control and process data and information by executing software, logic, code, or carrying out any other suitable functions. A server, as a computing device, may include any hardware, firmware, software, or a combination. In the most compact form, a server may be built on a single processor chip. In the figure, module 18 may contain one or more server entities that collect, process, maintain, and/or manage information and documents, perform computing and communication functions, interact with users, deliver information required by users or arranged by schedules, etc. Database 12 may be used to store the main information and data related to users, the facility, and service providers who use the facility. The database may include aforementioned memory chips and/or storage modules.

A communication network 14 may cover a range of entities such as the Internet or the World Wide Web, a local area network (LAN), a wide area network (WAN), a metropolitan area network (MAN), a telephone network, an intranet, wireless, and other types of networks. Client 80 and facility 82 may be connected to network 14 by various wired, wireless, optical, or other connections.

Client 80 may include an optical sensor 10 which tracks the eye of user using mature eye-tracking technologies. For some smartphone and tablet computer, sensor 10 may be a regular front-facing camera module used to take pictures by user in daily life. The sensor may be arranged very close to the screen of display and to sense the facial part of user. The system may recognize whether a user gazes at the display screen of client 80. In a more advanced mode, sensor 10 may be used to determine where a user is looking at of a screen, places such as screen top, bottom, left edge, right edge, or a particular area, etc. Sensor 10 may be built using imaging technologies, and the image of eye may be analyzed to decide which direction a user is looking at through algorithms. Both visible and infrared light may be employed for eye-tracking purpose. In the latter case, infrared light source may be arranged to provide a probing beam.

Sensor 10 may also be used to sense the gesture of user, especially certain finger or hand gesture. With proper algorithm, user gesture may be analyzed and interpreted as input instructions. A user may interact with a device by moving finger or hand in the air. As there is no need to touch a device, command by gesture provides an easy and convenient way to control a device or presentation of information on a device. In particular for some wall-mount smart displays at public venue, gesture instructions may become useful and important, since touching a displaying device placed far and high may be difficult. A smart display may be an interactive device with certain computing power and gesture sensing capability. It may work mainly as a display for presenting information. A user may enter input to control what to show on it and how to show it.

Client 80 may include a sensor 20, which is of global positioning system (GPS). Sensor 20 may enable a device to get its own location info. Besides GPS, device location may also be obtained using wireless triangulation methods, or other suitable technologies, which may be provided by service provider or on-site service facility. Usually for indoor or some urban environment, positioning methods other than GPS are used, since GPS requires a clear view of the sky or clear line of sight for four GPS satellites.

Client 80 may also include a proximity sensor 44 to detect whether a device is close to human body or held in hand, or whether a finger or hand is hovering above a display screen. Proximity sensing technologies are well known in the art and many smartphones have such a function already. Related technologies include infrared, capacitive, inductive, or other suitable schemes.

Furthermore, client 80 may contain a motion sensor 24 to detect its own movement by sensing acceleration, deceleration, and rotation. Sensor 24 may employ one or multiple accelerometers, gyroscopes, and/or pressure sensor for performing various measurement tasks which may include detecting device shaking, device vibration, device moving, and so on. These measurements help detect conditions and environment of users and devices. They also make it possible to use shaking, knocking, waving, and other device movement to convey user instructions.

Inside client 80, output signals of sensors may be transmitted to processor 16, which, employed with certain algorithms, may process the data and act according to predefined programs. For instance, processor 16 may process data from sensor 10, extract user gesture data, and then convert the data into user instructions. If gesture instructions ask a scroll process to pause, client 80 may make the scroll pause. If the instructions ask for more contents, client 80 may send a request to service facility 82. Facility 82 may retrieve additional info from database 12 or other sources and transmit it to client 80 for an updated presentation.

FIG. 2 shows exemplarily a schematic flow diagram illustrating one embodiment according to the present invention. The essence is to present contents on a computer or smartphone screen utilizing auto-scroll method so that a user may be able to sit back and watch contents somewhat like watching television for a period of time. Usually contents contain a lot of information and need multiple screen views to be presented. To view all contents, a user may scroll a page or turn page constantly. With auto scroll, contents may be presented in multiple steps or by multiple screen views automatically within a given time period, assuming contents are divided and formatted to fit the screen and there is no need to move page left or right. When a scroll cycle is done, it may start a new cycle by itself unless a user intervenes. So, a user may relax and watch contents effortlessly. But unlike television program, contents on a computer or smart phone screen may be interactive, such as containing links to web pages. In addition, a user may change the scroll rate and other scroll characteristics when needed.

Back to FIG. 2. Assume a user is with a smartphone. In Step 100 of the figure, the smartphone may be at one setting, for instance, State A. Next, the user may start content show in auto-scroll mode and have a chance to select scroll options in Step 102. For instance, a setup sign or icon may show up on a screen. Once the setup icon is activated, by tapping or clicking for example, a list may appear to display scroll options. The setup icon may also be arranged visible during a scroll session, so that a user has easy access to it and may change setup or setup value conveniently. The options may include scroll choices, like scrolling by paragraph, section, or page. Other options may include scroll rate, scroll direction, maximum number of scroll cycle per session, and maximum session time. Scroll rate is inversely proportional to the time a screen view remains unchanged on a display. Slower scroll rate means longer time a screen view stays on display. A scroll cycle is of the whole scroll process during which all contents are shown. Maximum number of scroll cycle means the maximum times contents are presented in a session. Once the maximum number is reached, the session may end and content show stops. Maximum session time is another criterion to end a scroll session. After setup, the user may start content show with auto scroll, which is reflected in Step 104, where contents are presented and scrolled automatically and continuously. In Step 106, the user may have two options: Stop showing contents or continue to do it. Step 106 may be implemented using virtual or physical buttons, and a user may push, tap, or click on a button to end the show or activate another button to keep it going. If no action is taken by user, it may be defined as a command to either stop scrolling or continue scrolling depending on setup arrangement. If the show is terminated, the device may return to State A; otherwise, it may reach Step 108, where a checkup is performed to detect whether a scroll cycle has come to an end, or the last part of contents has been presented. If it is not the end of cycle, the scroll may continue and it may go back to Step 104. If all contents are displayed, the scroll cycle is over. But since the user is passively involved and may want to watch some content one more time, or may have missed some part inadvertently, the scroll may be designed to restart in Step 110. As a result, it may return to Step 104 as well. A scroll cycle may end and then restart automatically, if the maximum cycle number is not reached and the user doesn't stop it. As it may not need a user to do anything once a scroll session begins, the method is in particular useful for laid-back users. As scroll rate may be a factor users adjust frequently, a scroll rate button may be arranged on screen. The button may look like an adjustable column whose height represents rate value. Thus a user may change the column height to tune the scroll rate conveniently.

Contents presented on a device may include any category of information such as breaking news, regular news, market updates, photos, chats, emails, text messages, video contents, advertisements, essays, articles, fictions, or other info arranged on a web page. A user may have options to choose what information to be presented. A user may also rely on a program and/or a service provider to supply contents. A service provider may be connected to a user device via service facilities, servers, and communication networks. Contents may come from live broadcast, database at a service facility, or device's own storage media.

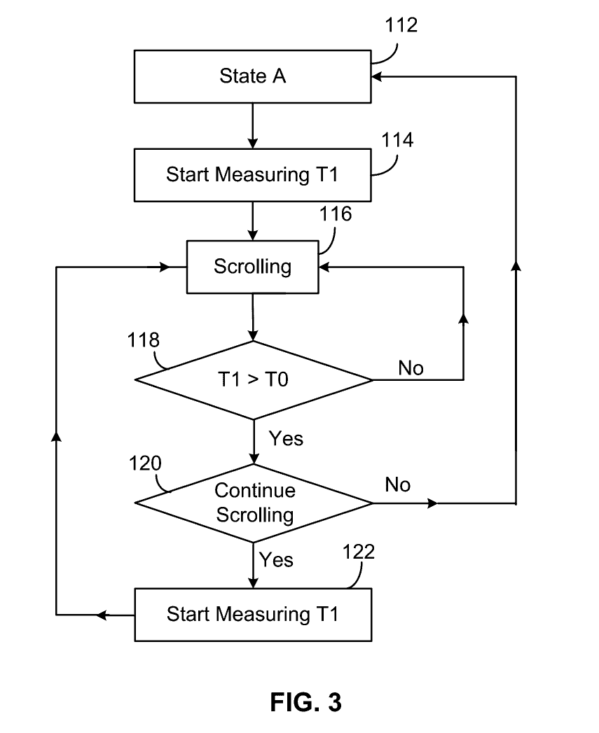

FIG. 3 shows a schematic flow diagram illustrating another embodiment according to the present invention. Compared to the example of FIG. 2, scrolling implemented here may not be going on forever in any cases and a user may have to make a selection after a period of time. Although continuous scroll requires the least effort from user and may be desirable by some people, it may meet with difficulty when power consumption is a concern, as an unattended device may not enter energy-saving state automatically in the absence of user activity. In Step 112, a device is at State A. The device may be of phone, watch, or others having a display and computing capability. Assume user's input is received at the device, some contents are displayed, and scroll session gets started. At this moment, a timing component begins to measure time T1 in Step 114. Next in Step 116, content show and auto scroll are in progress. Meanwhile, time measurement continues. In Step 118, if T1's value is smaller than a given number T0, say three to ten minutes, it goes back to Step 116 to continue the scrolling session. A scrolling session may contain multiple scroll cycles to show contents more than one time. If T1, the time period measured, is equal or larger than T0, Step 120 is taken, where a user may make a decision to continue scrolling or not to. For instance, a tap may be required to give “Yes” or “No” answer for question like “Continue Scrolling?” or “Scroll?”, assuming that the screen is touch sensitive with “soft” or virtual buttons, or there are physical buttons. If the answer is negative or there is no answer detected within a given period of time, the contents may be withdrawn and the device may return to State A in Step 112. If a “yes” answer is received in time, meaning a user may still want to watch the contents, the ongoing timing period may end and another measurement of T1 may start over in Step 122. Next, it goes to Step 116 to continue content presentation.

Content scroll may take many forms, such as scrolling by line, by paragraph, by section, or by page, depending on user preference. Assume contents may be shown by multiple pages. Then scroll may make one page turned and another show up consecutively. Scroll rate determines the time period during which a page or screen view is presented. As people's reading speed or habit is different, scroll rate may be adjusted by users respectively.

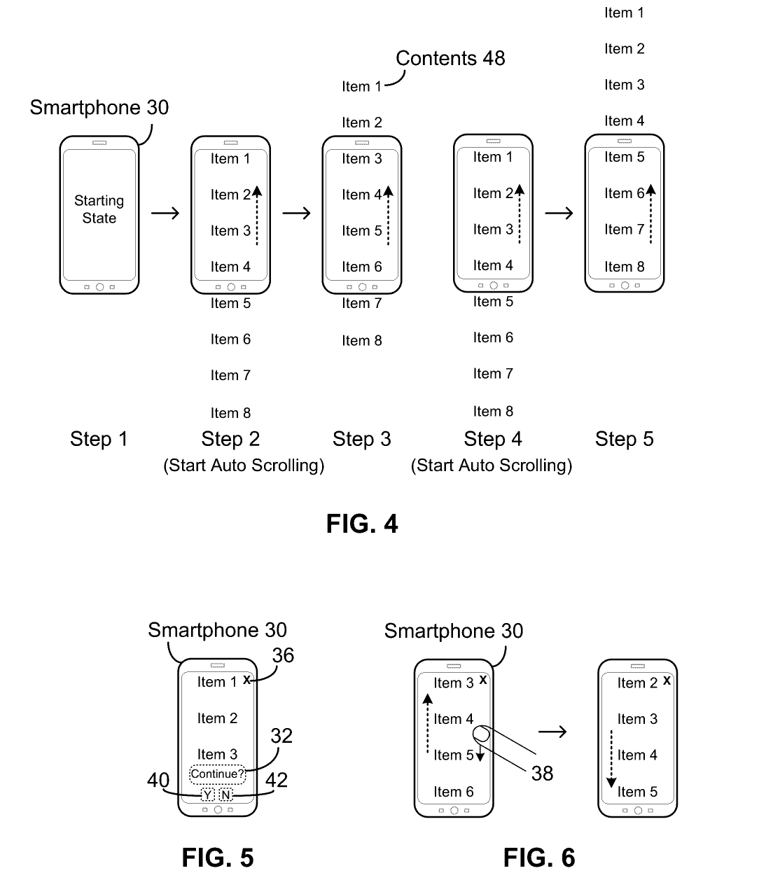

FIG. 4 shows a series of graphical diagram to illustrate two embodiments according to the present invention. A smartphone 30 is used as an example. In Step 1, the phone screen is with a starting state. Then a user starts a content show, and part of contents 48 appears on the screen in Step 2. After that, screen view changes consecutively due to auto scroll process. Assume contents 48 contain eight individual content items. The phone screen, as in most cases, is too small to show all items with one view. As a consequence, it displays four items each time. A scroll cycle is completed when all eight items are presented. The scroll may be scheduled to show two new items in each move, as depicted in Steps 2 and 3. Alternatively in a scroll process, contents may change by one item, three items, or four items, depending on user setup and scroll options. For instance from Step 4 to Step 5, four items are replaced in one scroll action. As a screen view or page contains four items, scroll from Step 4 to Step 5 may be considered as scroll by page as well. After item 8 is presented, a scroll cycle comes to an end, and then a new cycle may start over automatically. As discussed previously, a scroll cycle may be designed to restart multiple times unless a user intervenes to end it, or a check point may be arranged to let user make a decision after a given period of time or given number of cycle.

FIG. 5 shows an exemplary diagram to describe details of some embodiments. On the screen of smartphone 30, there may be a sign 32 and three buttons, 36, 40, and 42. Button 36, having a “X” mark, may appear on the upper right corner at all time during a scroll cycle. Once button 36 is tapped, it causes closure of the content window and ending of scroll session. Sign 32, as an icon, may show up periodically, e.g., once in three to ten minutes. The “Continue?” sign forces a user to decide whether to continue content show and scrolling or stop them. If “yes” button 40 is tapped, the scroll continues. If “no” button 42 is selected or no selection, the scroll process stops. Then sign 32 may become “Resume?” and a user may tap on button 40 to resume scrolling. If button 42 is tapped or no response is taken within a predetermined period of time, the content window may shut off, and the screen may return to its original mode. As smartphone 30 may have sensors of various types, other input schemes may be designed to make it easy and convenient for users. For instance, with voice recognition module, a user may say “Close it” to end a content show, instead of tapping the “X” button. Saying “yes” or “no” may replace tapping button 40 or 42 respectively. Furthermore, “yes” answer may be entered by shaking, waving, or knocking the phone after “Continue?” sign appears on screen. The shake, waving, or knock action may be detected by accelerometer sensor like sensor 24 of FIG. 1. On the other hand, if eye-tracking technology is used via, for instance, sensor 10 of FIG. 1, button tapping may be skipped. For example, if a user doesn't gaze at the screen for certain period of time, the content show may end automatically. If it is detected that a user keeps gazing at the screen, the user for sure wants to watch more. Then answering “Continue?” becomes unnecessary. So a scroll session may be controlled by device movement, user voice, and eye movement.

In FIG. 6, another embodiment is schematically illustrated using smartphone 30. During a scroll cycle, contents may be designed to move up in a forward direction, as people in general may want to read the top portion of screen first. But sometimes a user may want contents to scroll down in a backward direction, especially after a scroll cycle is completed. Thus it may be designed such that scroll direction may be reversed by a short swipe on a touch-sensitive screen. In the figure, the tip of a finger 38 makes a short downward slide or swipe on the screen surface. Then, the scroll direction is changed from upward to downward or from forward to backward. Scroll direction may also be changed via buttons specially designed. For instance, two arrow icons may be arranged on screen, pointing upward and downward. Tapping or clicking on an arrow icon may cause contents on screen to scroll along the arrow direction.

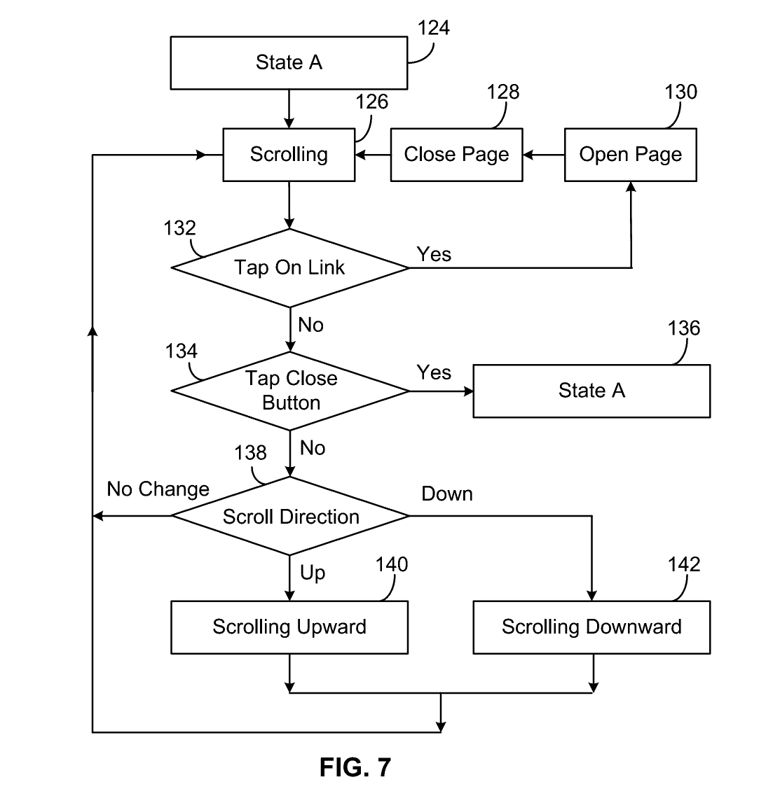

Introduced in the above contains basic scroll processes and features, which, in practice, may include more functions and options for users, as shown exemplarily in a flow diagram in FIG. 7. The flow diagram includes linkage to web pages, closing step, and scroll direction selection. It begins from State A, or Step 124, an arbitrary setting of the device. Next a user may choose to watch contents in auto-scroll mode, and then contents scrolls in Step 126. The contents may contain a list of titles of headline news. As active links to web pages may be available in the contents, one option is provided in Step 132. If a link is chosen and tapped or clicked, a corresponding web page may appear on screen in Step 130. For instance, if a user is interested in one event in the news, he or she may tap the title. Then a new page may open up with detailed report on the event. Once the new page is watched, the user may close it in Step 128. Next, it returns to step 126, and the scrolling process gets resumed. In a scroll session, a user may have another option in Step 134. If a “close” button is tapped, the screen goes back to State A in Step 136. Otherwise, one more option is presented in Step 138. A user may change the scroll direction by a short swipe on touch-sensitive screen or tapping on scroll direction button, such as arrow button. For instance, swiping down causes downward scrolling in Step 142, and doing it upward makes the opposite result in Step 140. If there is no input from user, the scroll direction remains unchanged. Whether the scroll direction is changed or not, in the next moment, it returns to Step 126, and the content show or scroll session continues.

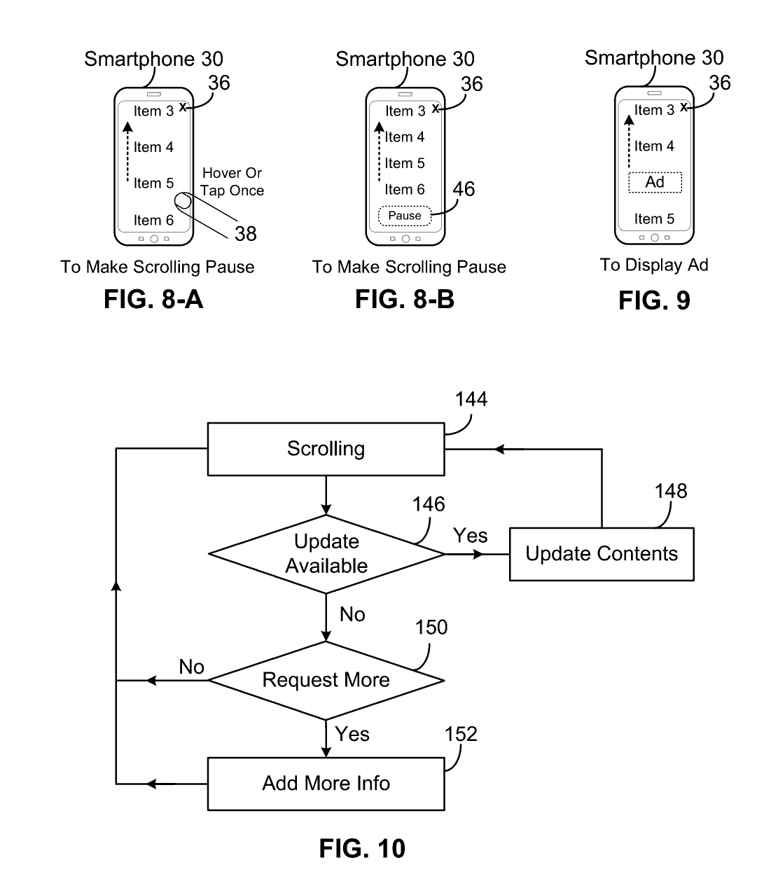

Auto scroll replaces contents on display at a given rate continuously without user involvement. But in reality, a user may be attracted by a piece of contents and may like to spend more time watching or reading it. Thus, it may be desirable that scroll process may pause when needed in a convenient and easy way. Some methods are described by illustrative diagrams shown in FIGS. 8-A and 8-B. For instance in FIG. 8-A, it may be designed such that a scroll would pause when a finger 38 taps on screen surface once. Not to be confused with opening an active link, it may be configured that one tap causes scroll to pause, while double taps activate a link and open up a web page. To make the operation smooth, scrolling may happen immediately and the scroll process may resume when another tap is received. In addition, it may also be designed such that putting a fingertip on a screen surface causes scroll to pause too. For instance, if a user puts a fingertip on a screen spot, scroll process may pause until the user removes his or her finger from the surface. Furthermore, for convenience, hand or fingertip hovering over a screen may also be designed to pause scrolling. Once the hand or fingertip moves away, the scroll may resume. Proximity module like sensor 44 of FIG. 1 may be used to detect finger or hand hovering above a screen. The hovering act is one type of gesture which may be used to convey user command or instructions.

Other types of user gesture may also be used as command input. For instance, a smart display may be installed for providing information in auto-scroll mode at public venue. The display may have certain computing capability and be able to take user instructions. As a display may be fastened on wall, away from a standing or sitting user, it may be inconvenient to touch its screen or button. Thus user gesturing may become a useful way to enter input. For example, it may be designed such that when a user holds his or her hand upright with palm facing a horizontal direction, a scroll session would pause. Once the user puts down the hand, the scroll resumes. In another scheme, a scroll may pause with “Scroll?” icon showing up on the display, when user's gesture of upright hand is detected. “Yes” and “No” icons may be arranged beside “Scroll?” icon similar to those in FIG. 5. Then the user may move his or her hand in the air to make selection. For instance, “Yes” and “No” icons may be arranged side by side horizontally, with one on the left and the other on the right. So a user may move hand to the left and then push it forward a bit, which may be interpreted as intention to select “Yes”. Similarly, moving hand to the right and then forward means choosing “No”. In another example, when an upright hand is detected, a “Scroll?” icon may show up with a hand-shaped mark on it. The hand-shaped mark may be designed to represent the relative position of user's hand. When the user moves hand in the air, the hand-shaped mark moves accordingly on the display. Then, the user may move the mark to overlap “Yes” or “No” button and then move hand or fingertip forward a bit as tapping the button to enter response.

In FIG. 8-B, another embodiment is depicted using smartphone 30. To configure another simple and easy method, a “Pause” button 46 is arranged on phone 30's screen. Button 46 may stay on screen while other contents are replaced or scrolled periodically. Tapping on button 46 may cause a scroll process to pause. Once scroll stops, “Pause” button may be replaced by “Resume” button, which, when tapped, resumes the scroll process. A user may also tap on button 36 to close the content window any time. As advertisement is of important revenue source for service provider, it may be arranged on screen with other contents. Ad may be placed in a fixed area of screen, or mixed with presentation contents and scroll with the flow as shown graphically in FIG. 9.

Contents may be displayed and scrolled continuously, in repeated cycles, to provide convenience for users favoring a relaxed viewing experience. But contents may change over time. For instance, headline news may be updated constantly. On the other hand, a user at times may want to watch more contents beyond what already shown on a device. These two needs are addressed in an illustrative flow diagram in FIG. 10. In Step 144, content scroll is ongoing. Next in Step 146, a checkup is performed to detect whether there is any update available. If there is update, Step 148 is performed to revise old contents and/or add new contents accordingly. Then it returns to Step 144, and contents continue to scroll. If there is no update, another check point appears in Step 150. It may be arranged such that an icon “More?” shows up on the screen, e.g., it may be arranged at the place of “Continue?” of FIG. 5. A user may tap on “yes” button if he or she wants to have more info or more categories of contents. If “no” button is tapped or there is no user response, it goes back to Step 144, to continue the show with existing contents and scroll process. If a user requests more info, additional materials may be sent from a remote center like service facility 82 of FIG. 1 and added to the presentation contents in Step 152. After that, it goes back to Step 144 with updated data and information.

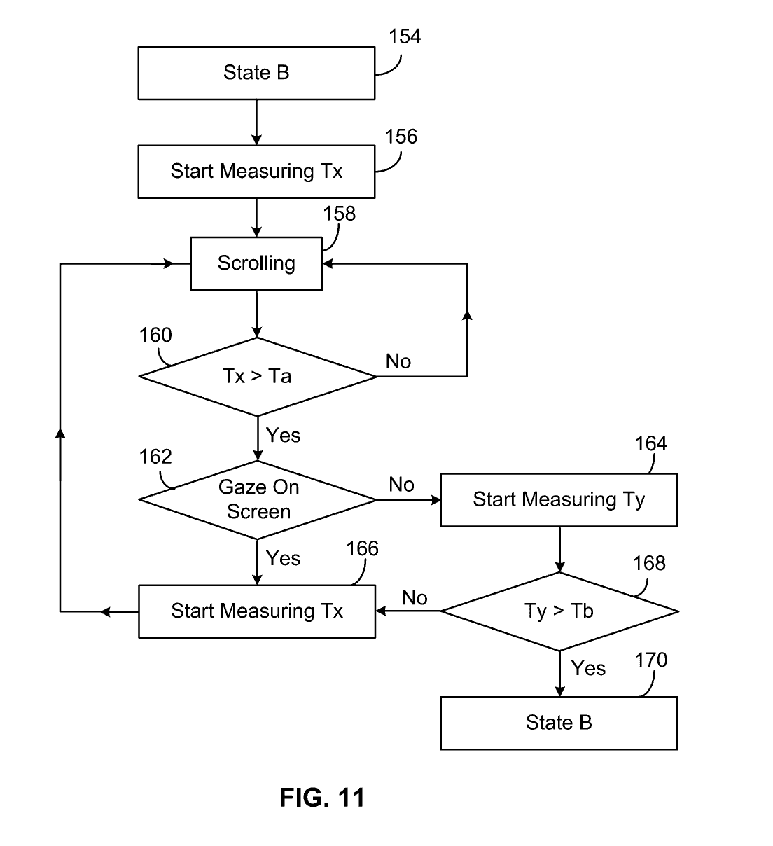

Now referring to FIG. 11. A flow diagram is used to describe schematically an embodiment that utilizes eye-tracking technology. In Step 154, the screen of a device shows State B, an arbitrary setting. Then a content show starts with auto scroll, and a measurement begins to record time period Tx in Step 156 through a timing module. Next, contents are presented and scrolled in Step 158, followed by Step 160 which checks whether Tx measured has reached a given value Ta, e.g., about two to five or ten minutes. If Tx is smaller than Ta, it goes back to Step 158 and the scroll continues. If Tx becomes equal or larger than Ta, the gaze direction of user is detected and obtained in Step 162. If it is determined that the user gazes at the screen, the timing module is reset and a new round of Tx measurement begins in Step 166. Next it returns to Step 158. If it is detected that the user is not watching at the screen, anther time measurement gets started in Step 164, which measures a time period Ty during which the user looks elsewhere instead of the screen. In Step 168, if Ty lapses longer than another given value Tb, indicating the user's interest may be diverted to other activities, the content show may end and the screen return to State B in Step 170. If the user's attention comes back to the screen and gazes at it when Ty is still smaller than Tb, it may be assumed that the user probably wants to continue the content show. Thus, it may also go back to Step 158 to continue the scroll session, after re-starting Tx measurement in Step 166.

During auto-scroll session, a screen view has a given time period staying on display. The screen view changes or contents scrolls automatically after the time period is over. Auto-scroll process may bring convenience and comfort to some users. But since users in general don't gauge or estimate the time period, auto scroll may also come as a surprise, as it seems to happen randomly. To make scroll process smoother and more user friendly, an alert sign or signals may be arranged to remind user of the incoming content change. For instance, a “Scroll?” sign or icon may appear at the place of “Continue?” of FIG. 5, along with “Y” and “N” buttons for smartphone cases. A user may tap “Y” button to let scrolling happen immediately, or tap “N” to delay or stop scrolling. If “N” button is tapped, “Scroll?” may become “Resume Scroll?” sign, along with “yes” and “no” buttons. If “yes” button is tapped, scrolling may take place and then the scroll session may resume. If “no” button is tapped, the session may stop, and the content window may close. If the user doesn't respond to “Scroll?” sign, scrolling may happen after a short period of waiting time, say three to ten seconds. The scroll waiting time may be adjusted by user. Besides, certain kind of flashes of light may be used to alert user about the incoming content change caused by auto scroll. Alert sign or signals may be arranged to show up at the end of the given time period, or a short while before the end of the period.

For users not interested in viewing contents repeatedly in multiple cycles, it may be arranged such that a device may keep retrieving new info from a service facility and keep showing new contents. For instance, a user may request a service provider to feed new material only, so that new contents may be presented continuously.

FIGS. 8-A and 8-B introduce embodiments to stop a scroll process temporarily, and to give user more time to watch contents. On the other hand, sometimes a user may finish contents ahead of scheduled scrolling time and want to see the next page right away. Other times, a user may want to go back to the previous page to double check an item. Thus, it is desirable to arrange functionalities like on-screen buttons for turning page either forward or backward during a scroll session. And it is desirable that pages could be turned continuously. For instance, an arrow icon pointing from the right to the left may be placed on screen. Once the arrow is tapped or clicked, the page on screen may turn forward and then the original scroll process resumes. Similarly, an arrow icon pointing to the right direction may be arranged for turning page backwards. Alternatively, a long slide or swipe on touch-sensitive screen may be used to turn page too. For instance, a long slide from the right to the left or from bottom to top may be used to turn page forward, while a long slide or swipe along the opposite directions may turn page backward. Moreover, if gesture recognition system is available, a user may gesture to turn page too. For instance, assume a wall-mounted display has gesture detection capability. It may be designed such that when hand or fingertip moves from the right to the left or upward, page on display turns forward, while moving hand or fingertip to the right or downward makes page turn backward. When gesturing, it should be clear between user's hand and an engaged imaging sensor. And user's hand may be in any position, vertical, horizontal, or tilted. For hand gesture, both first and spread hand may be used. For finger gesture, a user may use one fingertip or multiple fingertips together. After a page is turned by user gesturing, the auto scroll process may resume.

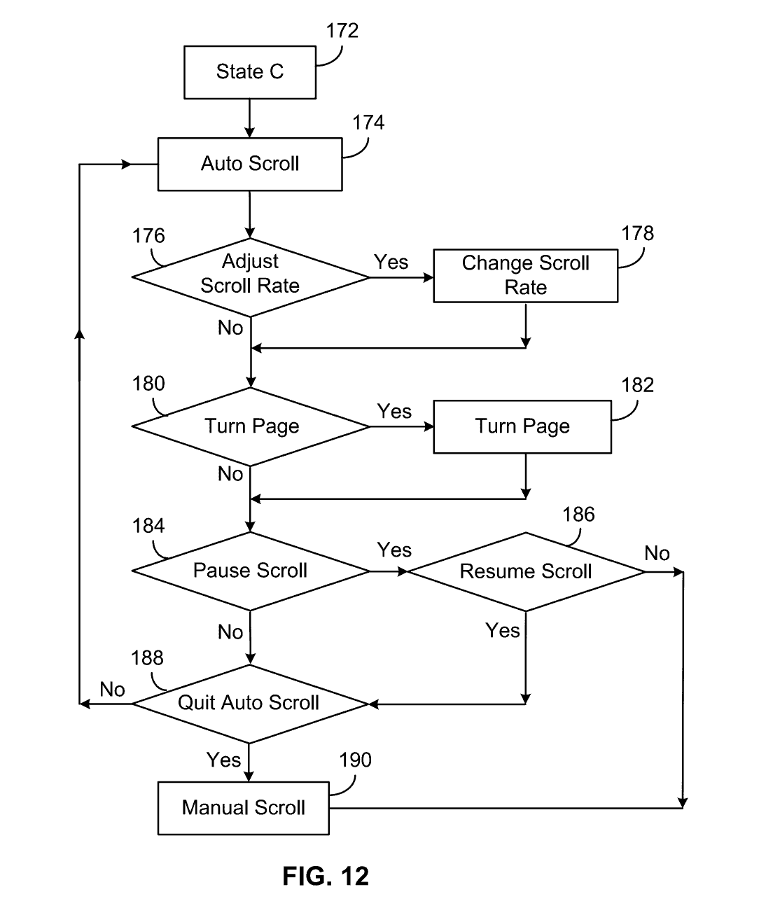

Now referring to FIG. 12, which shows an exemplary flow diagram combining several embodiments according to the invention. It begins from an arbitrary State C of a device in Step 172. Assume a user selects auto-scroll process when watching contents on display. Next contents scroll automatically in Step 174. The user may have an option to adjust the scroll rate in Step 176. Based on personal preference and the nature of contents, a user may want to change scroll rate to a comfortable level. Scroll rate may be represented by the value of time period during which a screen view stays on display. For instance, a time period may be in a range from five seconds to one or several minutes. In Step 178, a user may activate a setup button, select item of scroll rate, and then enter a value of time period. Next along the flow diagram, Step 180 provides an option to turn page manually. Page or pages may be turned forward or backward in Step 182 using icons arranged on screen. Next, an additional option is provided in Step 184 for scroll pause. When scroll pause happens, an option to resume scroll process is arranged in Step 186, which may be done using a “Resume Scroll” button on screen for example. In Step 188, an option to quit auto scroll is prepared. For instance, a “Quit Auto Scroll” button may be configured on screen. If the quit button is tapped or clicked, traditional mode of manual scroll returns in Step 190. If the quit button is not activated, it gets back to Step 174 to continue the scroll session. When a scroll session pauses beyond a given period of time in Step 186, it may leave the auto-scroll mode and go to the manual mode in Step 190.

### CONCLUSION, RAMIFICATIONS, AND SCOPE

Thus it can be seen that systems and methods are introduced to create relaxed viewing experience for users with sit-back mood.

The improved methods and systems have the following features and advantages:
(1). Scroll rate may be adjusted by user;
(2). Scroll cycle may restart by itself;
(3). Scroll process may be controlled by user gesture, voice, on-screen finger movement, and eye movement;
(4). Contents shown in a scroll session may be updated automatically; and
(5). Alert sign or signals may be presented before scrolling takes place;

Although the description above contains many specificities, these should not be construed as limiting the scope of the invention but as merely providing illustrations of some of the presently preferred embodiments. Numerous modifications will be obvious to those skilled in the art.

### Ramifications:

Some examples use smartphone for explanation. But as mentioned previously, embodiments introduced apply to other electronic devices as well, such as various kinds of computers, wireless devices, or wearable devices with computing functions.

In many embodiments described, tapping is singled out as a main method to enter input or interaction with a device. Although tapping is convenient and effective when a screen is touch sensitive, clicking may also be used to replace tapping when computer mouse, or touch pad are available.

A proximity sensor, along with other sensors, may be used to detect whether a smartphone or other gadgets are held by a hand and whether it is placed inside a pocket, purse, or bag. If it is determined that a phone is inside a closure, a content show may stop and the device may enter an energy-saving mode. In addition, a proximity sensor, when combined with other sensors, may be used to detect whether a device is shaking in hand, or shaking with something other than hand. And it may be arranged that only shaking or waving with hand is taken as user input.

Many user inputs discussed may be implemented by voice using speech recognition technology. So a user may only need to speak to a device to give instructions, like speaking “continue” to continue a scroll process, speaking “pause” to pause a scroll, speaking “more” to request more contents from a service center, etc.

Furthermore, a scroll session may pause or be terminated when certain violent motion is detected by accelerometer or gyroscope sensor, no matter a user is watching the screen or not, as it may be uncomfortable to view any content, or inappropriate to show any content in such a condition.

Moreover, a device may be equipped with facial recognition system. The system may at least recognize a device owner, which may protect user's privacy by not following other people's instructions. In addition, contents may be specifically prepared for identified user in a presentation. The system may use imaging detector like sensor 10 of FIG. 1 to get data and process the data with facial recognition algorithms to identify people.

To satisfy the condition of gazing at screen, the eye of a user may also fall on things located outside of a display but close to its edge, instead of looking directly at it. The reason is that, when a user looks at objects close to a display, contents shown on the display may also reach the eye, thus providing a viewing opportunity anyway. And hopefully, the user may turn his or her sight a bit to get a better reception of the contents. Moreover in many cases, instead of screen, it may be enough if a user just gazes at the device, because it may mean the user may have a good chance to notice contents displayed on the device. In fact in cases of smartphone and tablet computer, gazing at a device is almost equivalent to gazing at a screen, because for these devices, display screen may cover the majority area of one side.

Info presented in a scroll session may be more useful and effective if it is related to user location. Location info may be acquired using GPS sensor or other positioning technologies. For instance, if it is detected that a user is in city A, certain contents on city A may be selected and sent to the user. If a user goes to a shopping mall, relevant information like sales and promotion may be added to a content show.

A scroll process may pause when a user taps a screen once, uses a finger to press against a screen spot steadily, or lets finger or fingers hover above a screen, as described when discussing embodiments related to FIG. 8-A. Above scroll control acts may also be used to introduce more options. For instance, when a scroll pauses, a “Setup” sign or icon may show up. After the setup icon is tapped or activated, an option list may appear which may include scroll rate, scroll waiting time, content type, etc. A user may choose an option item and change the setup value or selection. Alternatively, a “Setup” icon may be arranged on screen during scroll process for easy access.

As the screen size of portable electronic devices may be small, such as smartphone and especially smartwatch and other wearable gadgets, it would be useful if a nearby display could be combined with a gadget to present contents. For instance, a smartphone or smartwatch may be connected to a display and a user may use it as his or her designated display temporarily. The connection between a personal device and standalone display may be realized by various mature technologies, like Wi-Fi, Bluetooth, optical, or wired methods. Once connected, a message may be transmitted to a service facility to notify change of display. Then contents formatted for large screen size may be sent to user for better viewing experience. Meanwhile, auto-scroll process may be applied to the connected display. A user may use a smartphone or smart watch to enter response or instructions, or use functions of the connected display to control presentation process. When a separate display and its input functionalities are fully utilized, it may be valuable for users with tiny-screen wearable devices, in particular users with devices having no display. Then users may enjoy the benefits of small or tiny device, big screen, and auto-scroll method at the same time.

Lastly, using eye-tracking technology, it may be detected which type of content catches more of user's attention. Then, similar type of content may be retrieved and presented to the user in a scroll session.

Therefore the scope of the invention should be determined by the appended claims and their legal equivalents, rather than by the examples given.

1. A system having stored executable instructions, comprising:
1) connection component for connecting said system to an electronic device and/or a communication network;
2) providing means for providing a plurality of contents to said system;
3) dividing means for arranging said plurality of contents into a plurality of portions;
4) presentation means for presenting to a user said plurality of portions orderly on a display in a presentation cycle;
5) said system configured such that each of said plurality of portions is presented for a given time period during said presentation cycle, said given time period arranged adjustable by said user;
6) said system configured such that said cycle restarts automatically after said plurality of portions are presented each time; and
7) control means for said user to control the presentation.

2. The system according to claim 1 wherein the direction of said presentation cycle is adjustable by said user.

3. The system according to claim 1, further including alerting means for generating alerting sign or signals around the end of said given time period.

4. The system according to claim 1 wherein said plurality of contents are updated automatically.

5. The system according to claim 1 wherein said control means includes influencing the presentation using the gesture, voice, or detection of eye movement of said user.

6. The system according to claim 1 wherein said control means includes influencing the presentation through tapping or pressing on the screen of said display.

7. The system according to claim 1 wherein said plurality of contents include sponsored information and/or a plurality of links to a plurality of web pages.

8. A method performed for presenting information comprising:
1) providing an electronic system and stored executable instructions;
2) connecting said system to an electronic device and/or a communication network;
3) providing a plurality of contents to said system;
4) dividing said plurality of contents into a plurality of portions;
5) presenting said plurality of portions orderly using a display in a presentation cycle;
6) arranging control means for a user to control the presentation;
7) said system configured such that each of said plurality of portions is presented for a given time period during said presentation cycle, said given time period arranged adjustable by said user; and
8) restarting said cycle automatically after said plurality of portions are presented each time.

9. The method according to claim 8 wherein the direction of said presentation cycle is adjustable by said user.

10. The method according to claim 8, further including generating alerting sign or signals around the end of said given time period.

11. The method according to claim 8 wherein said plurality of contents are updated automatically.

12. The method according to claim 8, further including influencing the presentation using the gesture, voice, or detection of eye movement of said user.

13. The method according to claim 8, further including tapping or pressing on the screen of said display to influence the presentation.

14. The method according to claim 8 wherein said plurality of portions include sponsored information and/or a plurality of links to a plurality of web pages.

15. A system having stored executable instructions, comprising:
1) connection component for connecting said system to an electronic device and/or a communication network;
2) providing means for providing a plurality of contents to said system;
3) dividing means for arranging said plurality of contents into a plurality of portions;
4) presentation means for presenting said plurality of portions orderly on a display in a presentation session;
5) said system configured such that each of said plurality of portions is presented for a given time period during said presentation session;
6) alerting means for generating alerting sign or signals around the end of said given time period; and
7) control means for said user to control the presentation.

16. The system according to claim 15 wherein the order to present said plurality of contents is adjustable by said user.

17. The system according to claim 15, further including adjusting means for adjusting said given time period by said user.

18. The system according to claim 15 wherein said plurality of contents are updated automatically.

19. The system according to claim 15 wherein said control means includes influencing the presentation using the gesture, voice, or detection of eye movement of said user or by tapping or pressing on the screen of said display.

20. The system according to claim 15 wherein said plurality of portions include sponsored information and/or a plurality of links to a plurality of web pages.
